(19) United States
(12) Patent Application Publication
(10) Pub. No.: US 2008/0178532 A1
(43) Pub. Date: Jul. 31, 2008

(54) Sealing Arrangements for Automotive Doors

(75) Inventor: Kuen C. Leung, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/627,479

(22) Filed: Jan. 26, 2007

(51) Int. Cl. E06B 7/16

(52) U.S. Cl. 49/490.1

(57) ABSTRACT

A seal mounting flange projects from automotive body structure into a door opening and receives a U-shaped base portion of a seal that seals with the periphery of an automotive door. The U-shaped base portion has ribs extending therefrom that function as barbs which engage the flange or engage a ramp or bead on the flange to prevent the seal from being dislodged from the door opening. The seal includes a pair of joined tubular portions that are relatively flexible and are flattened upon closing the door to seal with the door.

### FIELD OF THE INVENTION

The present invention relates to sealing arrangements for automotive doors. More particularly, the present invention relates to ergonomic configurations for primary seal carriers that ease installation of door seals in door openings of automotive vehicles.

### BACKGROUND OF THE INVENTION

Automotive vehicles are configured with an automotive body having door openings defined by inwardly facing peripheries on which doors are mounted. Most doors are pivoted on the opening and swing to close, while other doors slide and shift to close. The usual practice is to place a seal arrangement adjacent to the periphery of the opening for sealing engagement with a surface of the door which is usually in the form of a peripheral land. In order to secure the sealing arrangement to the door opening, a flange is provided over which a base portion of the seal is positioned. The flange is then crimped over the base portion of the seal to retain the seal in the door opening over the expected life of the vehicle. This crimping operation requires a crimping tool that squeezes the base portion of the sealing arrangement. The crimping tool is expensive in and of itself and requires maintenance and attention, which when combined with labor costs, add expense to the assembly of automotive vehicles.

In view of the aforementioned considerations, there is a need for an arrangement wherein door seals are mounted and retained without the use of a crimping tool.

### SUMMARY OF THE INVENTION

An automotive door sealing arrangement is configured to facilitate mounting and retaining a door seal adjacent to a periphery of a door opening in an automotive vehicle without crimping of a retaining flange, wherein the seal is mounted adjacent to the door opening with a low insertion force and is retained adjacent to the door opening with a high extraction force.

In the automotive door sealing arrangement, the door seal is mounted on a flange cantilevered adjacent to the periphery of the door opening. The flange has an attached edge and a free edge, and has an inner surface facing toward the automotive body and outer surface facing away from the automotive body. The door seal comprises a U-shaped base having outer and inner portions spaced from one another and connected by a bight portion to define a slot therebetween. A collapsible sealing portion projects from the outer portion for sealing engagement with the automotive door and a flexible lip portion extends from the bight portion for covering body structure disposed adjacent to the opening in spaced relation to the flange. A resilient spacer engages and urges the outer portion of the U-shaped base away from the flange, and a retaining rib is disposed on the inner portion of the U-shaped base and extends toward the flange. The retaining rib has a first bias when engaging one of the surfaces of the flange to deflect the rib upon pushing the U-shaped base over the flange and a second bias which prevents the seal from backing out of engagement with the flange. Consequently, the U-shaped base is retained on the flange by the second bias.

In one aspect of the sealing arrangement, the surface of the rib is planar and the second bias occurs upon attempting to deflect the rib in a reverse direction.

In another aspect of the sealing arrangement, the retaining rib engages a stop surface on a sealing ramp to positively retain the retaining rib on the flange.

In still another aspect of the sealing arrangement, the retaining rib engages a bead on the flange to positively retain the retaining rib on the flange.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a perspective side view of an automotive vehicle showing an automotive body having a door opening therein that has a peripheral seal arrangement configured to seal with a door mounted adjacent to the opening;

FIG. 2 is an inside view of the door opening of FIG. 1 prior to installing the seal;

FIG. 3 is a perspective view of a portion of a peripheral portion of the door opening of FIG. 2;

FIG. 4 is a view similar to FIG. 2 but showing the seal installed.

FIG. 5 is an elevation taken through FIG. 1 showing a first embodiment of the automotive door sealing arrangement prior to mounting the sealing arrangement on a flange positioned at the periphery of the door opening;

FIG. 6 is a side elevation similar to FIG. 5 showing the sealing arrangement retained on the flange at the periphery of the door opening with the automotive door open;

FIG. 7 is a view similar to FIG. 6 but showing the automotive door closed and compressing the seal;

FIG. 8 is a view similar to FIG. 6, but showing a second embodiment of the automotive door sealing arrangement, and

FIG. 9 is a view similar to FIGS. 5-8 but showing a third embodiment of the sealing arrangement.

### DETAILED DESCRIPTION

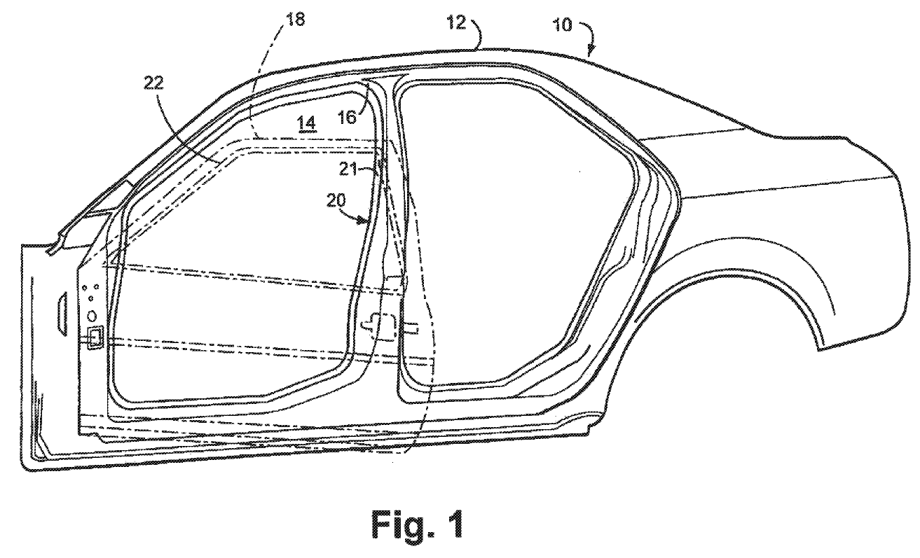

Referring now to FIG. 1 there is shown an automotive vehicle 10 having a body 12 with an opening 14 for receiving an automotive door 18 which is mounted adjacent the opening to move between an open and closed position. The opening 14 has a peripheral portion 16 on which is mounted a sealing arrangement 20 which seals with a relatively rigid, peripheral land portion 22 on the inner surface of the door 18. As will be more fully explained hereinafter, the sealing arrangement 20 has a compressible portion for accomplishing the seal 21 and a resilient portion which serves as a seal carrier for mounting the seal adjacent to the periphery of the door opening.

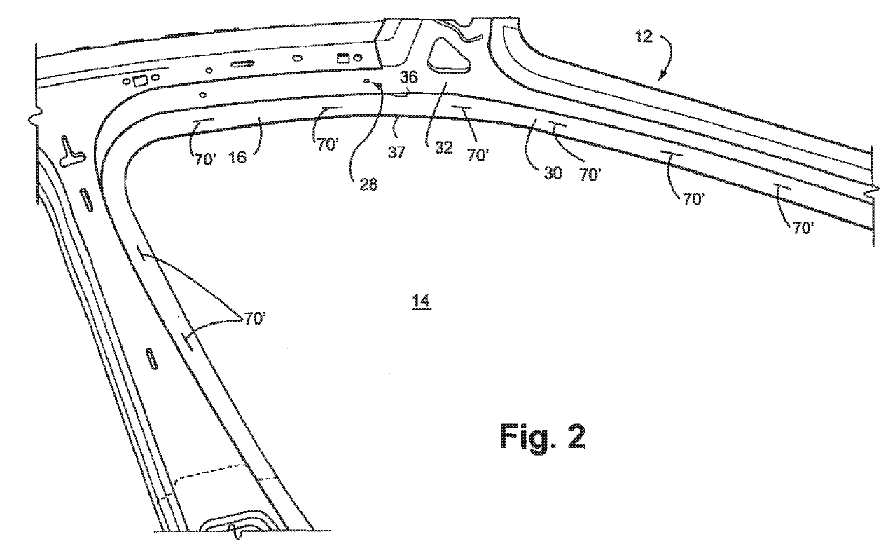

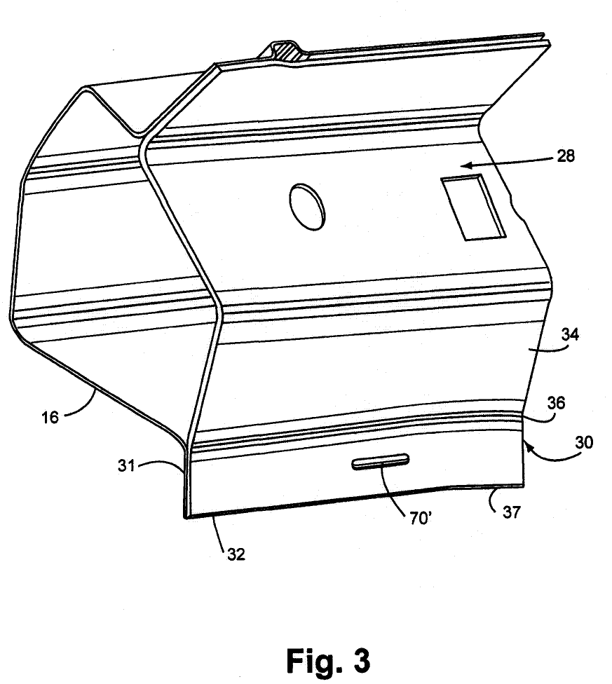

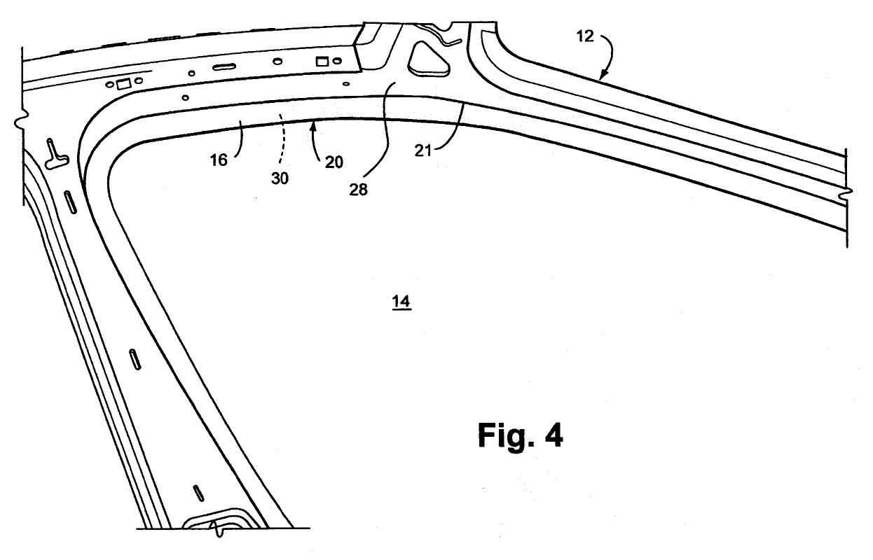

FIG. 2 is an inside view of the body frame showing a flange 30 upon which the seal 21 (FIG. 1) of the sealing arrangement 20 is mounted. The flange 30 is known in the art as a B & R flange, and as is seen in FIG. 3, is configured from welding an outer portion 31 of the body frame to an inner portion 32. As is seen in FIG. 4, the seal 21 is slid laterally over the flange 30 to form the sealing arrangement 20.

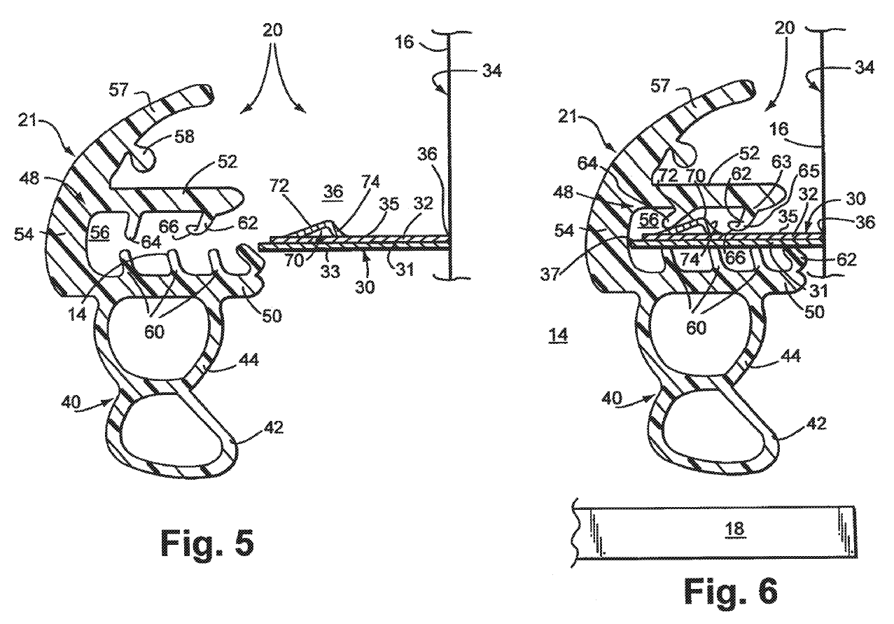

Referring now to FIGS. 5, 6 and 7, where a first embodiment of the sealing arrangement 20 is shown in elevation, the sealing arrangement 20 has a substantially constant cross section throughout its extension while mounted at the periphery 16 of the door opening 14 shown in FIGS. 1, 2 and 4. As is seen in FIG. 2, the sealing arrangement 20 relies on cooperation between vehicle body structure adjacent the door opening 14 and the seal 21. The automotive body structure adjacent the door opening 10 includes the flange 30, which is preferably comprised of a lamination of an outer plate 31 and an inner plate 32, but may include as many as four plates or maybe a single plate. An area 34 behind the flange 30 provides space for interior molding for the vehicle cabin.

The seal 21 includes a compressible sealing portion 40 comprised of a pair of superimposed compressible tubes 42 and 44, each vented to the atmosphere and pressed against the peripheral land 22 of the door 18 to seal therewith when the door is shut. The tube 44 is unitary with a U-shaped base 48 having an outer portion 50 and an inner portion 52 joined by a bight 54 to define a slot 56. The U-shaped base 48 functions a seal carrier for the compressible sealing portion 40. Extending inwardly from the U-shaped base 48 toward the body of the automobile 10 is a lip 57, which lip has a rib string 58 thereon that is pulled so that the lip 57 can be made to cooperate with interior cabin structure on the inboard side of the flange 30.

As is shown in FIG. 6, to install the seal 21 on the periphery 16 of the door opening 14, the seal 21 is pressed into place over the flange 30, which flange is received in the slot 56 defined between the outer portion 50 and inner portion 52 of the U-shaped base 48. In order to have a low insertion force, but high retention or extraction force with respect to the flange 30, the outer portion 50 of the U-shaped base 48 has a plurality of ribs 60 which are oriented to slant back toward the bight 54 of the base, while the inner portion 52 has a retaining rib 62 and a stabilizing rib 64 which also slant back toward the bight 54. The retaining rib 62 is triangular in cross section with a base 63 substantially wider than the tip 65. Thus, the ribs 60, 62 and 64 act as barbs allowing relatively easy insertion of the flange 30 into the opening 56, but difficult extraction of the flange from the opening. The ribs 60 on the outer portion 50 of the U-shaped base 48 provide a spacer arrangement that urges the outer portion away from the flange 30 so that the retaining rib 62 and stabilizing rib 64 are urged into engagement with the flange.

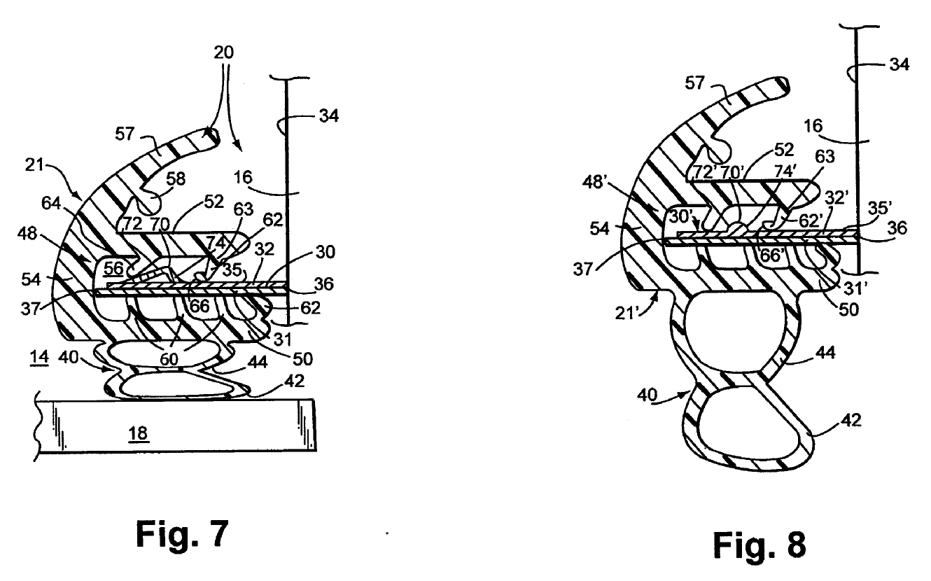

FIG. 7 shows the automotive door 18 closed against the seal 40 to flatten or compress the outer and inner tubes 42 and 44 against the U-shaped base 48 forming the seal carrier, thus, sealing the door opening 14.

As is seen in FIGS. 5-9, the retaining rib 62 has a locking tab 66 thereon, which in the embodiment of FIGS. 5, 6 and 7, interacts with a ramp 70. The ramp 70 has a ramp surface 72 and a stop surface 74. The ramp surface 72 deflects the retaining rib 62 by bending the retaining rib back toward the inner portion 52 of the U-shaped base 48 until the retaining rib clears the ramp 70. Thereafter, the retaining rib 62 snaps back to seat the locking tab 66 behind the stop surface 74 on the ramp 70. When a force is applied to the seal 21 tending to remove the seal 21 from the flange 30, there is positive engagement between the locking tab 66 and the surface 74 that prevents removal of the seal. The ramp 70 may be continuous on the flange 30, or may be intermittent with gaps between ramp portions.

Referring now to FIG. 8, the ramp 70 is reconfigured as a bead 70′ in accordance with a second embodiment of the invention. The bead 70′ is either continuous or in the form of short bead sections. As with the ramp 70 of FIGS. 5-7, the bead 70′ has a ramp surface 72′ and a stop surface 74′ with the ramp surface 72′ deflecting the retaining rib 62′ and the stop surface 74′ engaging the locking tab 66′ to positively retain the seal 21′ on the flange 30′.

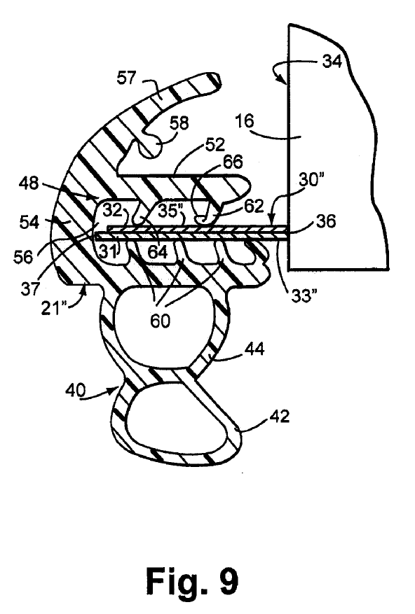

FIG. 9 discloses a third embodiment of the invention wherein a flange 30″ does not have the ramp 70 of FIG. 1 or bead 70′ of FIG. 2, but rather retains the seal 21″ on the flange 30″ by friction between the free ends of the ribs 60 engaging the bottom surface 33″ of flange 30″ and the rib 64 and retaining rib 62 engaging the top surface 35″ of the flange 30″. Since the ribs 60 and 64 and retaining rib 62 slant back toward the bight 54 of the U-shaped base, the ribs 60 and 64 and the retaining rib 62 functioning as barbs that are forced into tighter engagement with the surfaces 33″ and 35″ in reaction to a force applied to remove the seal 21″ from the flange 30″. The insertion force for the flange 30″ is substantially less than the reverse force or retraction force occurring upon attempting to bend the retaining rib 62 counter to its slant.

By so configuring the automotive door sealing arrangement 22 as set forth in the embodiments of FIGS. 5-9, it is no longer necessary to crimp the flanges 30, 30′ and 30″ in order to retain the seal 21 in place on the flanges. Thus, assembly is eased, crimping tools are no longer necessary and assembly is ergonomically friendly.

From the foregoing description, one skilled in the art can easily ascertain the essential characteristics of this invention, and without departing form the spirit and scope thereof, can make various changes and modifications of the invention to adapt it to various usages and conditions.

We claim:

1. An automotive door sealing arrangement for an automotive vehicle wherein a door seal is mounted adjacent to a periphery of a door opening in an automotive body for sealing cooperation with a surface of a door that is closed against the seal, the sealing arrangement comprising:
a flange cantilevered adjacent to the periphery of the door opening, the flange having an attached edge and a free edge, and having an inner surface facing toward the automotive body and outer surface facing away from the automotive body;
a door seal comprising a U-shaped base portion having an outer portion and an inner portion spaced from one another and connected by a bight portion to define a slot therebetween; a collapsible seal portion projecting from the outer portion for sealing engagement with the automotive door, and a flexible lip extending from the bight for covering body structure disposed adjacent to the opening in spaced relation to the flange;
a spacer arrangement for engaging and urging the outer portion of the U-shaped base away from the flange; and
a retaining rib on the inner portion of the U-shaped base and extending toward the flange, the retaining rib having a first bias when engaging an inner surface of the flange to deflect the retaining rib upon pushing the U-shaped base over the flange, and having a second bias to prevent the seal from backing out of engagement with the flange, whereby the U-shaped base is retained on the flange by pushing the U-shaped base over the flange.

2. The sealing arrangement of claim 1 wherein the retaining rib slants back toward the bight of the U-shaped base.

3. The sealing arrangement of claim 2 wherein the retaining rib is thicker where the retaining rib joins the inner portion of the U-shaped base than where it engages the inner surface of the flange.

4. The sealing arrangement of claim 3 wherein a locking tab extends from the retaining rib back toward the inner portion of the U-shaped base.

5. The sealing arrangement of claim 1 wherein the inner surface of the flange includes a ramp integral therewith, the ramp having a ramp surface facing the free edge of the flange and a stop surface facing away from the free edge of the flange.

6. The sealing arrangement of claim 5 wherein the ramp surface engages and deflects the retaining rib upon the U-shaped base being slid over the flange and wherein the seal is retained positively on the flange by the retaining rib engaging the stop surface of the ramp.

7. The sealing arrangement of claim 1 wherein the inner surface of the flange includes a ramp integral therewith, the ramp having a ramp surface facing the free edge of the flange and a stop surface facing away from the free edge of the flange.

8. The sealing arrangement of claim 7 wherein the ramp surface engages and deflects the retaining rib upon the U-shaped base being slid over the flange and wherein the seal is retained positively on the flange by the retaining rib engaging the stop surface of the ramp.

9. The sealing arrangement of claim 1 wherein a continuous bead is disposed along the inner surface of the flange for engaging the retaining rib to positively couple the seal to the flange.

10. The sealing arrangement of claim 1 wherein the bead sections are disposed in spaced relation along the inner surface of the flange for engaging the retaining rib to positively couple the seal to the flange.

11. The sealing arrangement of claim 3 wherein the spacer arrangement comprises ribs that slant back toward the bight of the U-shaped base, wherein the ribs form barbs that with the retaining rib engage the flange to resist removal of the door seal from the flange.
